(19) United States
(12) Patent Application Publication
(10) Pub. No.: US 2018/0366260 A1
(43) Pub. Date: Dec. 20, 2018

(54) DEVICE FOR FORMING TRANSMISSION COIL OF WIRELESS POWER TRANSMITTER, TRANSMISSION COIL MODULE, AND MANUFACTURING METHOD THEREFOR

(71) Applicant: LG INNOTEK CO., LTD., Seoul (KR)

(72) Inventor: Dong Ho YONG, Seoul (KR)

(73) Assignee: LG INNOTEK CO., LTD., Seoul (KR)

(21) Appl. No.: 16/060,815

(22) PCT Filed: Dec. 6, 2016
(86) PCT No.: PCT/KR2016/014196

§ 371 Date: Jun. 8, 2018

(30) Foreign Application Priority Data
Dec. 9, 2015 (KR) 10-2015-0175048
Dec. 9, 2015 (KR) 10-2015-0175053

(51) Int. Cl. H01F 27/32; H01F 27/28; H01F 41/04; H01F 41/12; H02J 50/10

(52) U.S. Cl. CPC H01F 27/323; H01F 27/2804; H01F 41/041; H01F 2027/2809; H01F 41/122; H02J 50/10; H01F 27/2885

(57) ABSTRACT

The present invention relates to a wireless power transmission technology. A transmission coil module of a wireless power transmitter, according to an embodiment of the present invention, may comprise: a transmission coil for transmitting wireless power, and a guide substrate comprising at least one coil guide for preventing contact between neighboring conducting wireless of the transmission coil and a coil reception unit for receiving the transmission coil.

### TECHNICAL FIELD

The present invention relates to a wireless power transmission technology, and more particularly, to a transmission coil forming device of a wireless power transmitter, a transmission coil module, and a method of manufacturing therefor.

### BACKGROUND ART

Recently, in accordance with the rapid development of information and communication technologies, ubiquitous society is realized based on the information and communication technologies.

In order to access IT devices at anytime and anywhere, it is necessary to install sensors in which a computer chip equipped with a communication function is embedded in all social facilities. An issue of supplying power provided to the devices and the sensors is becoming a new challenge. As a type of a portable device such as a cellular phone, a Bluetooth handset, a music player (e.g., iPod), and the like is rapidly increasing, recharging a battery requires time and effort for a user. As a solution for the problem, a wireless power transmission technology is recently getting a spotlight.

Wireless power transmission technology (or wireless energy transfer technology) corresponds to a technology that enables a transmitter to wirelessly transmit electrical energy to a receiver using a magnetic field induction principle. In the 1800s, it has already started to use an electric motor or a transformer using electromagnetic induction principle. Thereafter, a method of transmitting electric energy by emitting an electromagnetic wave such as a radio wave or laser has been attempted. A frequently used electric toothbrush or a wireless shaver is charged based on the electromagnetic induction principle.

Currently, a wireless energy transfer method is mainly classified into an electromagnetic induction method, an electromagnetic resonance method, and an RF transmission method using a short wavelength radio frequency.

According to the electromagnetic induction method, when two coils are adjacent to each other, if a current flows through one coil, magnetic flux is generated and the magnetic flux causes electromotive force on another coil. The electromagnetic induction method is rapidly deployed on a commercial scale centering on a hand-held device such as a cellular phone. The electromagnetic induction method can transmit power as much as maximum several hundred kilowatt (kW) and has high efficiency. However, since maximum transmission length is equal to or less than 1 cm, the electromagnetic induction method has a demerit in that it is necessary to place a device near a charger or a floor in general.

The electromagnetic resonance method has a characteristic that uses an electromagnetic field or a magnetic field rather than an electromagnetic wave or a current. Since the electromagnetic resonance method is nearly impervious to an electromagnetic wave problem, the electromagnetic resonance method has a merit in that it is safe to use the electromagnetic resonance method for a different electronic device or a human body. On the other hand, the electromagnetic resonance method has a demerit in that the method is used in a confined distance and space only and has a little bit lower energy transfer efficiency.

The short wavelength wireless power transmission method—simply, RF transmission method—utilizes a point that energy is directly transmitted and received in a radio wave form. This technology corresponds to a wireless power transmission method of an RF scheme using a rectenna. The rectenna is a mixed word using antenna and rectifier. The rectenna corresponds to an element configured to covert RF power into direct current power. In particular, the RF method is a technology that converts AC radio wave into DC. Recently, efficiency of the RF method is increased and ongoing effort to commercialize the RF method is actively performed.

A wireless power transmission technology can be utilized not only for mobile industry but also for IT, railroad, car, home appliance industry, and the like.

Recently, a wireless power transmitter on which a plurality of coils are mounted is manufacturing to increase a recognition rate of a wireless power receiver laid on a charging bed. And, in order to increase a power transmission efficiency of the wireless power transmitter, it is required to increase a size of each of a plurality of the coils and thickness of conducting wires constructing a coil.

However, if the thickness of the conducting wires constructing a coil increases, since it is difficult to attach film (PI film) for maintaining a shape of the coil, conducting wires adjacent to each other are contacted and a short may occur.

Meanwhile, if it is difficult to attach film for maintaining a shape to a coil and the coil is manufactured while being exposed to the external, it is highly probable that the coil is going to be contaminated by foreign substance.

And, each of a plurality of coils is implemented by a coil of which a conducting wire is wounded with the many number of turns. The coil has high resistance due to a proximity effect. In particular, a problem of degrading power transmission efficiency occurs due to the high resistance.

And, a short may occur due to a contact between conducting wires adjacent to each other of a coil. If a coil is exposed to the external, foreign substance may influence on the coil and the coil may fail to perform a normal operation. Hence, an effort of preventing the short is called for.

### DISCLOSURE OF THE INVENTION

### Technical Tasks

Accordingly, the present invention is designed to substantially obviate problems due to limitations and disadvantages of the related art. An object of the present invention is to provide a transmission coil forming device of a wireless power transmitter, a transmission coil module, and a method of manufacturing therefor.

Another object of the present invention is to provide a transmission coil module of a wireless power transmitter capable of preventing a short and contamination from foreign substance and a method of manufacturing therefor.

The other object of the present invention is to provide a transmission coil forming device of a wireless power transmitter capable of optimizing wireless power transmission efficiency, a transmission coil module, and a method of manufacturing therefor.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a transmission coil module of a wireless power transmitter can include a transmission coil for transmitting wireless power, at least one coil guide for preventing a contact between conducting wires adjacent to each other of the transmission coil, and a guide board including a coil accommodating unit accommodating the transmission coil.

Depending on an embodiment, the at least one coil guide includes a plurality of guide structures which are arranged in a direction vertical to a concentric circle direction of the transmission coil and each of a plurality of the guide structures can be positioned between the conducting wires adjacent to each other.

Depending on an embodiment, the number of a plurality of the guide structures may be identical to the number of winding up the transmission coil.

Depending on an embodiment, a gap between guide structures adjacent to each other among a plurality of the guide structures may be identical to a diameter of the conducting wires of the transmission coil.

Depending on an embodiment, a height of the coil accommodating unit may be identical to a diameter of the conducting wires of the transmission coil.

Depending on an embodiment, the transmission coil module of the wireless power transmitter can further include a shielding material configured to block a magnetic field of the transmission coil in a manner of being attached to the bottom of the guide board.

To further achieve these and other advantages and in accordance with the purpose of the present invention, according to a different embodiment, a method of manufacturing a transmission coil module of a wireless power transmitter includes the steps of forming at least one coil guide for preventing a contact between conducting wires adjacent to each other of a transmission coil for transmitting wireless power and a guide board including a coil accommodating unit accommodating the transmission coil, and inserting the transmission coil into the coil accommodating unit to insert the conducting wires of the transmission coil into the at least one coil guide.

To further achieve these and other advantages and in accordance with the purpose of the present invention, according to a different embodiment, a transmission coil forming device of a wireless power transmitter includes a transmission coil accommodating unit configured to accommodate a transmission coil for transmitting wireless power which is inserted via a transmission coil insertion unit and a transmission coil guide configured to physically separate conducting wires adjacent to each other of the transmission coil from each other.

Depending on an embodiment, the transmission coil guide may have a width predetermined to optimize a quality factor of the transmission coil.

Depending on an embodiment, the transmission coil accommodating unit may have a width identical to a diameter of the transmission coil.

Depending on an embodiment, the transmission coil accommodating unit may have a height identical to the half of a diameter of the transmission coil.

To further achieve these and other advantages and in accordance with the purpose of the present invention, according to a different embodiment, a transmission coil module of a wireless power transmitter includes a transmission coil for transmitting wireless power, a first transmission coil forming device containing a first transmission coil accommodating unit configured to accommodate a transmission coil inserted via a transmission coil insertion unit and a first transmission coil guide configured to physically separate conducting wires adjacent to each other of the transmission coil from each other, and a second transmission coil forming device attached to the first transmission coil forming device while having a structure symmetrical to a structure of the first transmission coil forming device.

To further achieve these and other advantages and in accordance with the purpose of the present invention, according to a different embodiment, a method of manufacturing a transmission coil module of a wireless power transmitter includes the steps of generating a first transmission coil forming device including a first transmission coil accommodating unit configured to accommodate a transmission coil for transmitting wireless power and a first transmission coil guide configured to physically separate conducting wires adjacent to each other of the transmission coil from each other, generating a second transmission coil forming device having a structure symmetrical to a structure of the first transmission coil forming device, attaching the first transmission coil forming device to the second transmission coil forming device in a manner that a face of the first transmission coil forming device is contacted with a face of the second transmission coil forming device, and inserting the transmission coil into a transmission coil accommodating unit which is formed by attaching the first transmission coil forming device to the second transmission coil forming device.

The embodiments of the present invention are just a part of preferred embodiments of the present invention. And, various embodiments to which technical characteristics of the present invention are reflected can be clearly induced and understood from the following description by those having ordinary skill in the technical field to which the present invention pertains.

The embodiments of the present invention are just a part of preferred embodiments of the present invention. And, various embodiments to which technical characteristics of the present invention are reflected can be clearly induced and understood from the following description by those having ordinary skill in the technical field to which the present invention pertains.

### Advantageous Effects

Accordingly, the present invention provides the following effects or advantages.

According to one embodiment of the present invention, it is able to prevent a short between an inner conducting wire and an outer conducting wire adjacent to each other of a transmission coil using a transmission coil module and a method of manufacturing therefor according to the present invention.

And, since a guide board protects a transmission coil from foreign substance, it is able to prevent the transmission coil from being contaminated.

According to a transmission coil forming device of a wireless power transmitter, a transmission coil module, and a method of manufacturing therefor, it is able to manufacture a transmission coil having the best quality factor by maintaining a space between conducting wires adjacent each other with a predetermined space.

And, it is able to prevent a short by physically separate adjacent conducting wires of a transmission coil from each other.

Moreover, it is able to prevent a transmission coil from being contaminated by foreign substance by protecting the transmission coil from the external.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram for explaining a procedure of transmitting a detection signal in a wireless power transmitter according to one embodiment of the present invention;

FIG. 2 is a flowchart for explaining a wireless power transmission procedure defined in WPC standard;

FIG. 3 is a flowchart for explaining a wireless power transmission procedure defined in PMA standard;

FIG. 4 is a diagram for explaining a wireless charging system based on an electromagnetic induction principle according to one embodiment of the present invention;

FIG. 5 is a front view of a transmission coil according to one embodiment of the present invention;

FIG. 6 is a diagram for a guide board accommodating a transmission coil shown in FIG. 5;

FIG. 7 is a diagram illustrating a state that a transmission coil is installed in a guide board;

FIG. 8 is a diagram more specifically illustrating a coupling structure that a transmission coil is installed in a guide board;

FIG. 9 is a diagram illustrating a cross section of a coupling structure shown in FIG. 8;

FIG. 10 is a diagram for one embodiment of a transmission coil module that shielding material is attached to a cross section of a coupling structure shown in FIG. 9;

FIG. 11 is a diagram for a different embodiment of a transmission coil module that shielding material is attached to a cross section of a coupling structure shown in FIG. 9;

FIG. 12 is a diagram of a transmission coil forming device for manufacturing a transmission coil module according to one embodiment of the present invention;

FIGS. 13 to 16 are diagrams for explaining a method of manufacturing a transmission coil module according to one embodiment of the present invention.

### BEST MODE

According to a first embodiment of the present invention, a transmission coil module of a wireless power transmitter can include a transmission coil for transmitting wireless power, at least one coil guide for preventing a contact between adjacent conducting wires of the transmission coil, and a guide board including an accommodating unit accommodating the transmission coil.

### Mode for Invention

In the following, a device to which embodiments of the present invention are applied and various methods are explained in more detail with reference to the accompanying drawings. In general, a suffix such as “module” and “unit” may be used to refer to elements or components. Use of such a suffix herein is merely intended to facilitate description of the specification, and the suffix itself is not intended to give any special meaning or function.

When an embodiment is explained, if it is described as configuration elements are formed at the “top (above) or bottom (below)”, the “top (above) or bottom (below)” includes both a case that two configuration elements are directly contacted and a case that one or more different configuration elements are deployed between the two configuration elements. And, if it is described as configuration elements are formed at the “top (above) or bottom (below)”, it may include not only a meaning of up direction but also a meaning of down direction on the basis of a single configuration element.

When the embodiments of the present invention are described, for clarity, a device configured to transmit wireless power in a wireless power system may be referred to as a wireless power transmitter, a wireless power transmission device, a wireless power transmission apparatus, a transmitting end, a transmission device, a transmitting side, a transmitter, and the like in a manner of being mixed. And, for clarity, a device configured to receive wireless power from a wireless power transmission device may be referred to as a wireless power receiver, a wireless power reception device, a wireless power reception apparatus, a receiving end, a reception device, a receiving side, a receiver, and the like in a manner of being mixed.

Basically, a transmitter according to the present invention may have a pad form, a cradle form, an AP (access point) form, a small base station from, a stand form, a form buried in ceiling, a wall-mount form, and the like. A transmitter can transmit power to a plurality of wireless power reception devices. To this end, the transmitter can be equipped with at least one wireless power transmission means. For example, a wireless power transmission means may use various wireless power transmission standards based on an electromagnetic induction scheme that charges a battery using an electromagnetic induction principle. According to the electromagnetic induction principle, a magnetic field is generated in a power transmitting end coil and electricity is induced in a receiving end coil due to the effect of the magnetic field. In this case, wireless power transmission standard of the electromagnetic induction scheme can include a wireless charging technology of electromagnetic induction scheme defined by WPC (Wireless Power Consortium) and/or PMA (Power Matters Alliance).

According to one embodiment of the present invention, a receiver can include at least one wireless power reception means and receive wireless power from two or more transmitters at the same time. In this case, the wireless power reception means can include a wireless charging technology of the electromagnetic induction scheme defined by WPC (Wireless Power Consortium) and PMA (Power Matters Alliance).

According to the present invention, the receiver can be used for a compact electronic device such as a mobile phone, a smartphone, a laptop computer, a digital broadcasting terminal, a PDA (personal digital assistants), a PMP (portable multimedia player), a navigation, MP3 player, a vibration toothbrush, an electronic tag, a lighting device, a remote controller, a float, a wearable device such as a smart watch, and the like, by which the present invention may be non-limited. If a device includes a wireless power reception means and is able to charge a battery, the device may become the receiver.

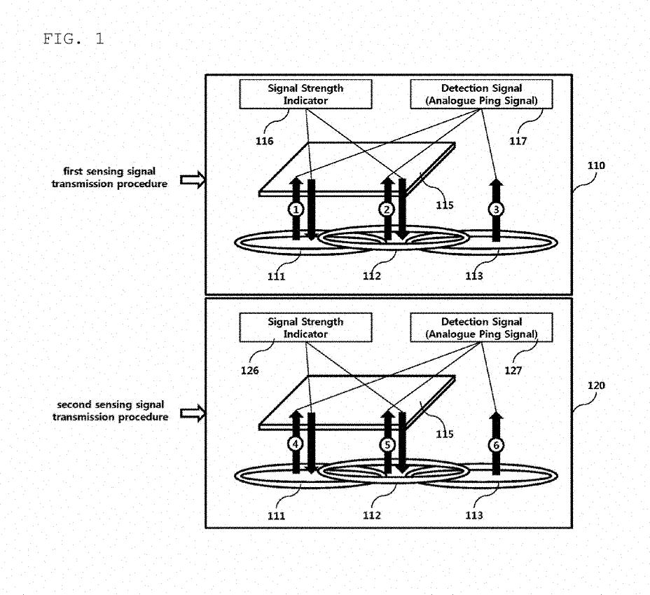

FIG. 1 is a diagram for explaining a procedure of transmitting a detection signal in a wireless power transmitter according to one embodiment of the present invention.

Referring to FIG. 1, a wireless power transmitter can include 3 transmission coils 111, 112, 113. A partial region of a transmission coil can be overlapped with a different transmission coil. The wireless power transmitter sequentially transmits prescribed detection signals 117/127, e.g., digital ping signals, for detecting the existence of a wireless power receiver via each of the transmission coils in a predefined order.

As shown in FIG. 1, the wireless power transmitter sequentially transmits detection signals 117 via a first detection signal transmission procedure shown in drawing number 110 and can identify transmission coils 111, 112 which have received a signal strength indicator 116 from a wireless power receiver 115. Subsequently, the wireless power transmitter sequentially transmits detection signals 127 via a second detection signal transmission procedure shown in drawing number 120, identifies a transmission coil having good power transmission efficiency (or charging efficiency), i.e., align status between a transmission coil and a reception coil, among transmission coils 111, 112, which have received a signal strength indicator 126, and controls power to be transmitted, i.e., wireless charging is to be performed, via the identified transmission coil.

As shown in FIG. 1, the wireless power transmitter performs the detection signal transmission procedure two times. This is aimed for more precisely identifying a transmission coil with which a reception coil of the wireless power receiver is aligned well.

As shown in drawing numbers 110 and 120 of FIG. 1, if the signal strength indicators 116, 126 are received in the first transmission coil 111 and the second transmission coil 112, the wireless power transmitter selects a transmission coil of the best alignment from among the first transmission coil and the second transmission coil based on the signal strength indicator 126 respectively received in the first transmission coil 111 and the second transmission coil 112 and performs wireless charging using the selected transmission coil.

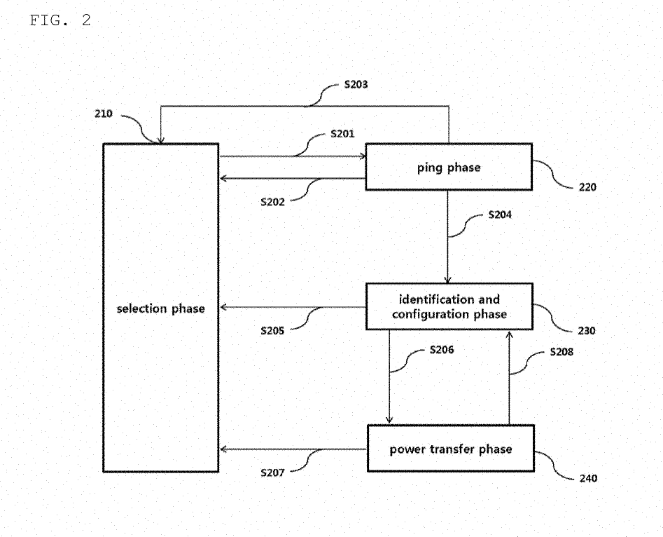

FIG. 2 is a flowchart for explaining a wireless power transmission procedure defined in WPC standard.

Referring to FIG. 2, power transmission from a transmitter to a receiver according to WPC standard can be mainly classified into a selection phase 210, a ping phase 220, identification and configuration phase 230, and a power transfer phase 240.

The selection phase 210 may correspond to a phase which is switched when a specific error or a specific event is sensed while power transmission is started or maintained. In this case, the specific error and the specific event can be clearly understood via the following description. In the selection phase 210, a transmitter can monitor whether or not an object exists on an interface surface. If the transmitter senses that an object is laid on the interface surface, the transmitter can switch to the ping phase 220 [S201]. In the selection phase 210, the transmitter transmits an analog ping signal of a very short pulse and can sense whether or not an object exists in an active area of the interface surface based on a current change of a transmission coil.

In the ping phase 220, if an object is sensed, the transmitter activates a receiver and transmits a digital ping to identify whether or not the receiver corresponds to a receiver compatible with WPC standard. In the ping phase 220, if the transmitter fails to receive a response signal, e.g., a signal strength indicator, from the receiver in response to the digital ping, the transmitter may switch back to the selection phase 210. In the ping phase 220, if the transmitter receives a signal indicating the completion of power transmission, i.e., charging completion signal, from the receiver, the transmitter may switch to the selection phase 210 [S203].

If the ping phase 220 ends, the transmitter can switch to the identification and configuration phase 230 to collect receiver identification information, receiver configuration information, and status information [S204].

In the identification and configuration phase 230, if an unexpected packet is received, if a packet is not received during predefined time (time out), if there is an error in transmitting a packet (transmission error), or if a power transmission contract is not configured (no power transfer contract), the transmitter can switch to the selection phase 210 [S205].

If a receiver is identified and configured, the transmitter can switch to the power transfer phase 240 for which wireless power is transmitted [S206].

In the power transfer phase 240, if an unexpected packet is received, if a packet is not received during predefined time (time out), if a violation for a predetermined power transfer contract occurs (power transfer contract violation), or if charging is completed, the transmitter can switch to the selection phase 210.

In the power transfer phase 240, if it is necessary to reconfigure a power transfer contract according to a status change of the transmitter, and the like, the transmitter can switch to the identification and configuration phase 230.

The abovementioned power transfer contract can be configured based on status and characteristic information of the transmitter and the receiver. For example, the status information of the transmitter can include information on a maximum amount of power capable of being transmitted by the transmitter, information on the maximum number of receivers capable of receiving power, and the like. The status information of the receiver can include information on requested power and the like.

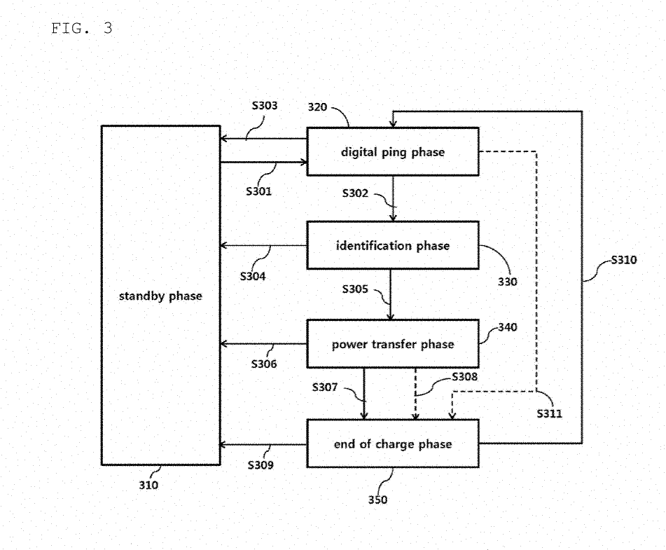

FIG. 3 is a flowchart for explaining a wireless power transmission procedure defined in PMA standard.

Referring to FIG. 3, power transmission from a transmitter to a receiver according to PMA standard can be mainly classified into a standby phase 310, a digital ping phase 320, an identification phase 330, a power transfer phase 340, and an end of charge phase 350.

The standby phase 310 may correspond to a phase which is switched when a specific error or a specific event is sensed while a receiver identification procedure for power transmission is performed or power transmission is maintained. In this case, the specific error and the specific event can be clearly understood via the following description. In the standby phase 310, a transmitter can monitor whether or not an object exists on a charging surface. If the transmitter senses that an object is laid on the charging surface or RXID reattempt is in progress, the transmitter can switch to the digital ping phase 320 [S301]. In this case, the RXID corresponds to a unique identifier assigned to a receiver compatible with PMA. In the standby phase 310, the transmitter transmits an analog ping signal of a very short pulse and can sense whether or not an object exists on an interface surface, e.g., an active area of a charging bed, based on a current change of a transmission coil.

Having switched to the digital ping phase 320, the transmitter transmits a digital ping signal to identify whether or not the sensed object corresponds to a PMA-compatible receiver. If sufficient power is supplied to the receiver based on the digital ping signal transmitted by the transmitter, the receiver modulates the digital ping signal received from the transmitter according to a PMA communication protocol and can transmit a prescribed response signal to the transmitter. In this case, the response signal can include a signal strength indicator indicating signal strength of power received in the receiver. In the digital ping phase 320, if a valid response signal is received, the receiver can switch to the identification phase 330 [S302].

In the digital ping phase 320, if a response signal is not received or if it is known as the receiver is not a PMA-compatible receiver, i.e., FOD (foreign object detection), the transmitter can switch to the standby phase 310. For example, an FD (foreign object) may correspond to a metal object.

In the identification phase 330, if a receiver identification procedure fails, if it is necessary to perform the receiver identification procedure again, or if it fails to complete the receiver identification procedure within predefined time, the transmitter can switch to the standby phase 310 [S304].

If the transmitter succeeds in identifying the receiver, the transmitter can start charging by switching to the power transfer phase 340 [S305].

In the power transfer phase 340, if a preferred signal is not received within predetermined time (time out), if an FO (foreign object) is sensed, or if voltage of a transmission coil exceeds a predetermined reference value, the transmitter can switch to the standby phase 310 [S306].

In the power transfer phase 340, if temperature sensed by a temperature sensor embedded in the transmitter exceeds a prescribed reference value, the transmitter can switch to the end of charge phase 350.

In the end of charge phase 350, if it is checked that the receiver is eliminated from the charging surface, the transmitter can switch to the standby phase 310 [S309].

In over temperature state, if temperature measured after prescribed time elapsed is equal to or less than a reference value, the transmitter can switch to the digital ping phase 320 from the end of charge phase 350 [S310].

In the digital ping phase 320 or the power transfer phase 340, if an EOC (end of charge) request is received from the receiver, the transmitter may switch to the end of charge phase 350 [S308 and S311].

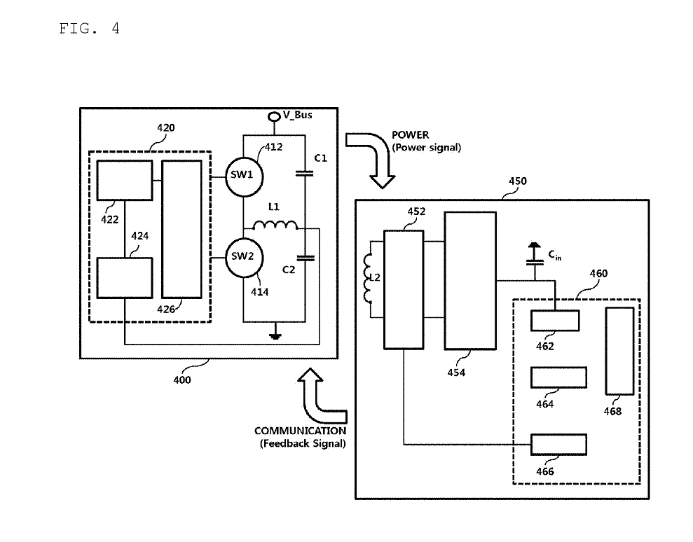

FIG. 4 is a diagram for explaining a wireless charging system based on an electromagnetic induction principle according to one embodiment of the present invention.

Referring to FIG. 4, a wireless charging system of an electromagnetic induction type includes a wireless power transmitter 400 and a wireless power receiver 450. The wireless power transmitter 400 and the wireless power receiver 450 are practically same with the wireless power transmitter and wireless power receiver mentioned earlier in FIG. 1, respectively.

If an electronic device including the wireless power receiver 450 is placed on the wireless power transmitter 400, coils of the wireless power transmitter 400 and coils of the wireless power receiver 450 can be combined with each other by the electromagnetic field.

The wireless power transmitter 400 can modulate a power signal and change a frequency to generate an electromagnetic field for power transmission. The wireless power receiver 450 receives power by demodulating an electromagnetic signal according to a protocol configured to be suitable for wireless communication environment and transmits a prescribed feedback signal for controlling the transmission power strength of the wireless power transmitter (400) to the wireless power transmitter 400 via in-band communication based on the strength of the received power. For example, the wireless power transmitter 400 may increase or decrease transmission power by controlling an operation frequency according to a control signal for controlling power.

Amount of transmission power (increase/decrease) can be controlled using a feedback signal transmitted from the wireless power receiver 450 to the wireless power transmitter 400. And, communication performed between the wireless power receiver 450 and the wireless power transmitter 400 is not restricted to the above mentioned in-band communication using the feedback signal only. The communication can also be performed using out-of-band communication equipped with a separate communication module. For example, it may use a short-range wireless communication module such as Bluetooth, BLE (Bluetooth Low Energy), NFC, Zigbee, and the like.

In the electromagnetic induction scheme, it may use a frequency modulation scheme as a protocol for exchanging status information and a control signal between the wireless power transmitter 400 and the wireless power receiver 450. It is able to exchange device identification information, charge status information, a power control signal and the like via the protocol.

According to one embodiment of the present invention, as shown in FIG. 4, the wireless power transmitter 400 includes a signal generator 420 configured to generate a power signal, a coil (L1) and capacitors (C1, C2) positioned between power supply ends (V_Bus, GND) capable of sensing a feedback signal delivered from the wireless power receiver 450, and switches (SW1, SW2) controlled by the signal generator 420. The signal generator 420 can be configured to include a demodulation unit 424 for demodulating a feedback signal delivered via the coil (L1), a frequency operating unit 426 for changing a frequency, a modulation unit 424, and a transmission controller 422 for controlling the frequency operating unit 426. The feedback signal delivered via the coil (L1) is demodulated by the demodulation unit 424 and is inputted into the transmission controller 422. The transmission controller 422 controls the frequency operating unit 426 based on the demodulated signal and can change a frequency of a power signal delivered to the coil (L1).

The wireless power receiver 450 can include a modulation unit 452 for transmitting a feedback signal via a coil (L2), a rectification unit 454 for converting AC signal received via the coil (L2) into DC signal, and a reception controller 460 for controlling the modulation unit 452 and the rectification unit 454. The reception controller 460 can include a power supply unit 462 for supplying power necessary for operations of the rectification unit 454 and the wireless power receiver 450, a DC-DC converting unit 464 necessary for the rectification unit 454 to convert output DC voltage into DC voltage matched with a charging condition of a charging target 468 (load), a load 468 configured to output converted power, and a feedback communication unit 466 configured to generate a feedback signal to provide reception power status, status of a charging target to the wireless power transmitter 400.

In FIG. 4, the coil (L1) included in the wireless power transmitter 400 corresponds to the 3 transmission coils 111, 112, 113 shown in FIG. 1. Switches (SW1, SW2) and capacitor (C1, C2) connected with the transmission coils 111, 112, 113 can be independently installed according to the transmission coil 111, 112, 113, by which the present invention may be non-limited.

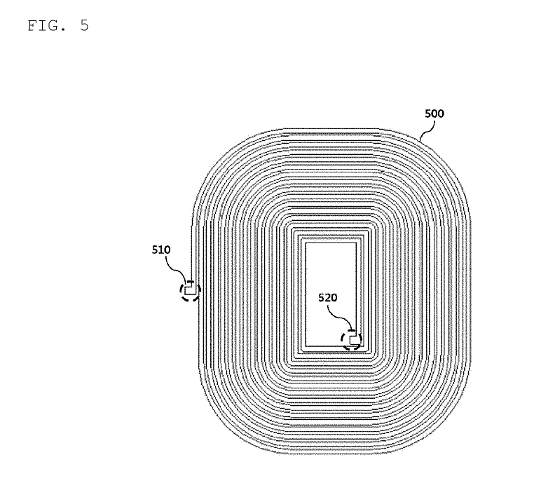

FIG. 5 is a front view of a transmission coil according to one embodiment of the present invention.

Referring to FIG. 5, although a transmission coil 500 is illustrated as a spiral structure close to a concentric square, by which the present invention may be non-limited. For example, the transmission coil 500 can be implemented by a spiral structure close to a circle. If the transmission coil has a structure that a conducting wire is wounded as a unibody, any modification can be made.

The transmission coil 500 can be manufactured by patterning both sides of a copper plate made of copper (Cu) with a shape of the transmission coil 500 and symmetrically performing etching process on both sides of the copper plate. The etching process can be performed on both sides sequentially or simultaneously.

The transmission coil 500, which is manufactured by the etching process, can be referred to as etching copper. Since conducting wires of the transmission coil 500 are manufactured by the etching process, the conducting wires may have a relatively big diameter (e.g., 500 um). Meanwhile, since the transmission coil 500 is manufactured by the etching process, it is difficult to attach film (PI film) for maintaining a shape of the coil to the coil. Hence, the transmission coil 500 can be attached to a PCB (printed circuit board) without attaching the film to the transmission coil. In this case, since it is difficult to maintain a shape of the transmission coil 500 and conducting wires adjacent to each other are contacted with each other, a short may occur. And, if the transmission coil 500 is exposed to the external, the transmission coil can be contaminated by foreign substance.

A first terminal 510 is formed at an outer end of the transmission coil 500 and a second terminal 520 can be formed at an internal end of the transmission coil 500. The first terminal 510 and the second terminal 520 correspond to opposite ends of the coil (L1) shown in FIG. 4 and can be connected with a control circuit board. The control circuit board corresponds to a board including configurations such as the switches (SW1, SW2), the signal generator 420, and the like that control an operation of the wireless power transmitter 400.

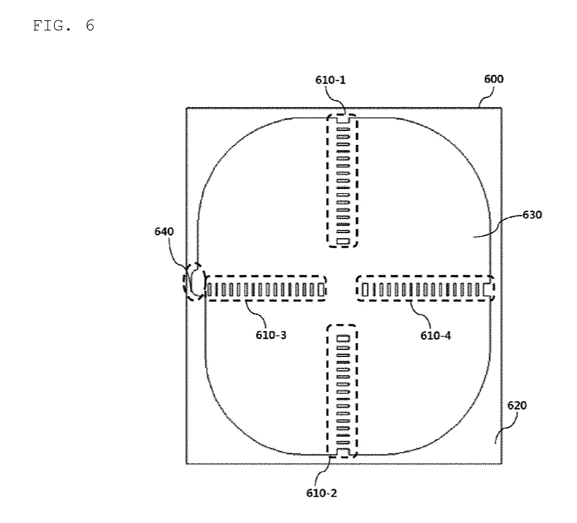

FIG. 6 is a diagram for a guide board accommodating a transmission coil shown in FIG. 5.

Referring to FIG. 6, a guide board 600 maintains a shape of the transmission coil 500 and can prevent a short capable of being occurred on the transmission coil 500.

The guide board 600 can include first to fourth coil guides 610-1 to 610-4, a coil outer guide 620, a coil accommodating unit 630, and a first terminal accommodating unit 640.

Each of the first to fourth coil guides 610-1 to 610-4 may have a form arranged in one direction among top, bottom, left, and right of the guide board 600. Each of the first to fourth coil guides 610-1 to 610-4 may include a guide structure positioned between an internal conducting wire and an external conducting wire to prevent a contact between the internal conducting wire and the external conducting wire of the transmission coil 500 wounded in a spiral form.

The number of guide structures included in each of the first to fourth coil guides 610-1 to 610-4 may be identical to the number of winding the transmission coil 500 (N:N is an integer equal to or greater than 1), by which the present invention may be non-limited. If the number of guide structures is identical to the number (N) of winding the transmission coil 500, it may be able to prevent all conducting wires ranging from the innermost conducting wire to the outermost conducting wire of the transmission coil 500 from being contacted with each other.

An arrangement of the guide structure included in each of the first to fourth coil guides 610-1 to 610-4 can be vertical to a direction of a concentric circle of the transmission coil 500.

A space between guide structures adjacent to each other can be equal to or greater than a diameter of conducting wires that construct the transmission coil 500, by which the present invention may be non-limited.

According to one embodiment of the present specification, each of the first to fourth coil guides 610-1 to 610-4 has a form of being arranged in one direction among top, bottom, left and right directions, by which the present invention may be non-limited.

In particular, the present invention relates to a structure for preventing a contact between adjacent conducting wires of the transmission coil 500. A position of coil guides, the number of coil guides, a position or the number of guide structure included in each coil guide can be modified.

For example, other coil guides can be formed not only in upper, bottom, left, and right directions but also in upper left, upper right, bottom left, and bottom right directions.

Depending on an embodiment, the number of coil guides and thickness of a coil guide can be determined in consideration of the characteristic of the transmission coil 500. In particular, if stiffness of the transmission coil 500 is low or the transmission coil is considerably deformed according to the increase of temperature, it may be able to increase the number of the coil guides and the thickness of the coil guide.

The coil outer guide 620 may have a shape corresponding to an outer shape of the transmission coil 500 and can support an outer of the transmission coil 500 to maintain the outer shape of the transmission coil 500. A height of an upper side of the coil outer guide 620 may be identical to a height of an upper side of each of the first to fourth coil guides 610-1 to 610-4.

The coil accommodating unit 630 may have a height lower than the height of the upper side of the coil outer guide 620 and the height of the upper side of each of the first to fourth coil guides 610-1 to 610-4 to make the transmission coil 500 to be accommodated in the inside of the guide board 600. The height can be equal to or greater than a diameter of conducting wires that construct the transmission coil 500, by which the present invention may be non-limited.

The first terminal accommodating unit 640 corresponds to a space that makes a first terminal 510 of the transmission coil 500 to be accommodated in the coil outer guide 620 and the coil accommodating unit 630.

The guide board 600 can be manufactured by performing a press process on an acrylic board or a plastic board, by which the present invention may be non-limited.

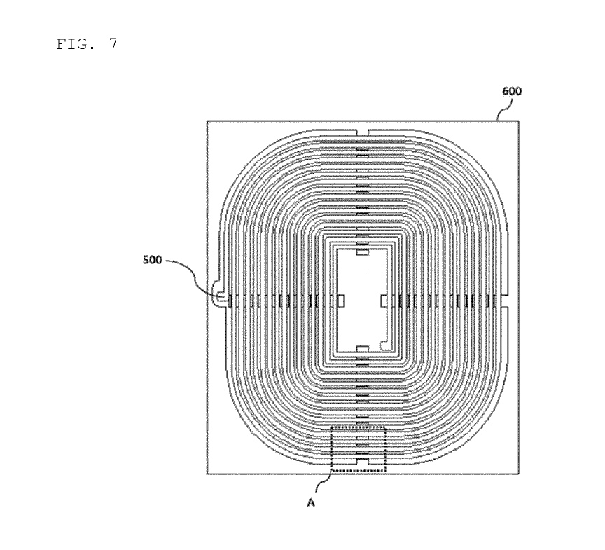

FIG. 7 is a diagram illustrating a state that a transmission coil is installed in the guide board mentioned earlier in FIG. 6.

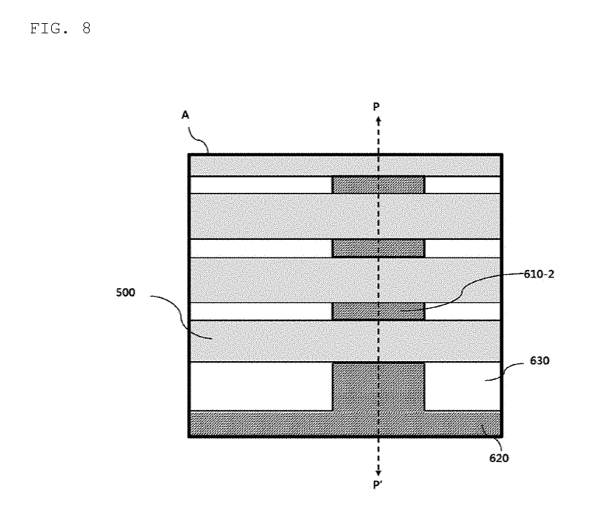

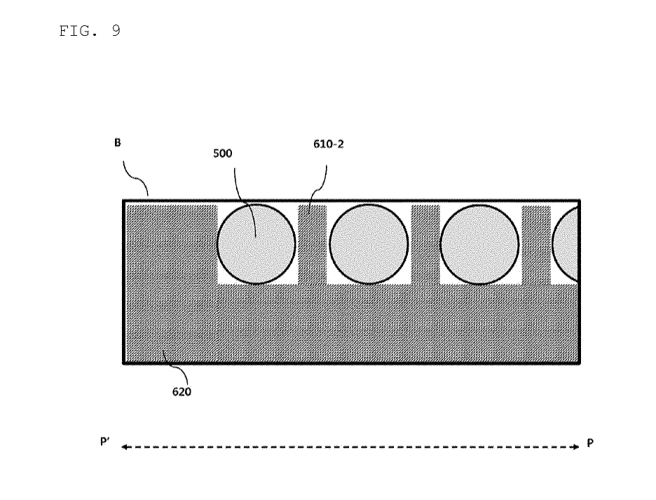

Referring to FIG. 7, as mentioned earlier in FIGS. 5 and 6, the transmission coil 500 is installed in the coil accommodating unit 630 of the guide board 600 and each of the first to fourth coil guides 610-1 to 610-4 prevents a contact between an inner conducting wire and an outer conducting wire of the transmission coil 500 wounded in a spiral form. In FIGS. 8 and 9, a coupling structure (A) that the transmission coil 500 is installed in the guide board 600 and a cross section (B) of the coupling structure (A) are explained in detail.

FIG. 8 is a diagram more specifically illustrating a coupling structure that a transmission coil is installed in a guide board. FIG. 9 is a diagram illustrating a cross section of the coupling structure shown in FIG. 8.

FIG. 8 illustrates a coupling structure (A) that the transmission coil 500 is installed in the guide board 600.

A second coil guide 610-2 provides a space into which each conducting wire of the coil 500 is inserted and makes an inner conducting wire and an outer conducting wire of the coil 500 not to be contacted. The outermost conducting wire can be inserted between the second coil guide 610-2 and the coil outer guide 620.

In FIG. 8, for clarity, the second coil guide 610-2 and the coil outer guide 620, which are made of the same material, are represented by the same diagonal line pattern. The coil accommodating unit 630, which is lower than a height of an upper side of the second coil guide 610-2 and a height of an upper side of the coil outer guide 620, is represented by no pattern.

FIG. 9 illustrates a cross section (B) formed by a vertical line (P-P′) of a coupling structure shown in FIG. 8.

Similar to what is mentioned earlier in FIG. 8, the second coil guide 610-2 and the coil outer guide 620 provide a space into which the transmission coil 500 is inserted. The Transmission coli 500 is inserted into the space and makes an inner conducting wire and an outer conducting wire not to be contacted.

By doing so, since it is able to prevent a short due to the contact between conducting wires, it is able to prevent a phenomenon that the transmission coil 500 is not properly working.

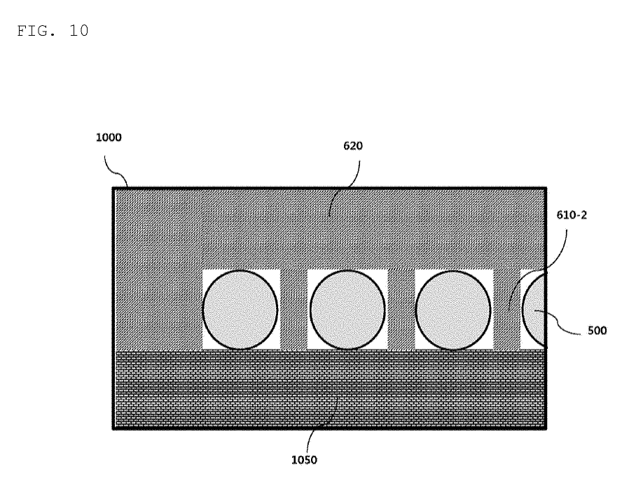

FIG. 10 is a diagram for one embodiment of a transmission coil module that shielding material is attached to a cross section of the coupling structure shown in FIG. 9.

Referring to FIG. 10, a transmission coil module 1000 can be configured in a manner that shielding material is directly attached to a bottom (although the cross section shown in FIG. 10 and the cross section shown in FIG. 9 are upside down, the bottom part shown in FIG. 9 is defined as an upper part) of a cross section (B) of a coupling structure that the transmission coil 500 is installed in the guide board 600. The shielding material 1050 can block a magnetic field radiated from the transmission coil 500 and performs a function of making the magnetic field to be radiated to the upper part only without affecting a control circuit board positioned at the bottom part.

In this case, a method of attaching the shielding material 1050 may include a method of using an additional adhesive sheet (e.g., double-sided tape), a method of applying synthetic resins having bonding strength and insulation (bonding method), and the like, by which the present invention may be non-limited. And, the shielding material may correspond to a ferrite sheet, by which the present invention may be non-limited.

PCB can be attached to the bottom part of the transmission coil module 1000. The transmission coil 500 can be electronically connected with the control circuit board via a connector installed in the PCB. To this end, the shielding material 1050 can include at least one or more holes through which conducting wires connected to each of the first terminal 510 and the second terminal 520 of the transmission coil 500 are passing.

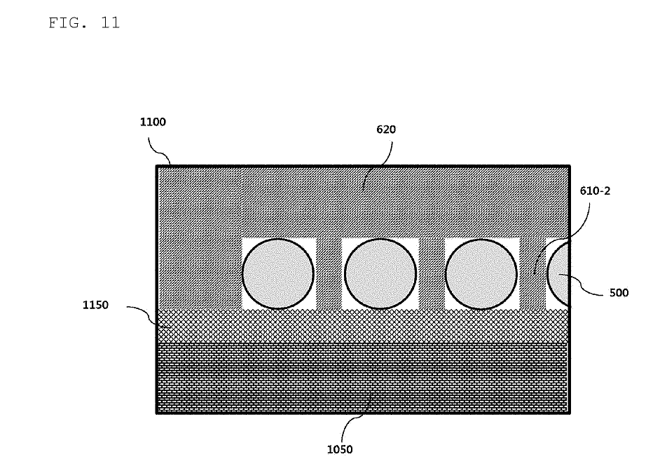

FIG. 11 is a diagram for a different embodiment of a transmission coil module that shielding material is attached to a cross section of a coupling structure shown in FIG. 9.

Referring to FIG. 11, the transmission coil module 1100 can further include auxiliary PCB 1150 between the shielding material 1050 and the cross section (B) while the shielding material 1050 is not directly attached to the bottom part of the cross section (B) of the coupling structure that the transmission coil 500 is installed in the guide board 600.

The auxiliary PCB 1150 can include a conducting wire pattern which is connected to a connector installed on the PCB, which is attached to the bottom part of the transmission coil module 1000, from a position of the first terminal 510 and a position of the second terminal 520, respectively. By doing so, it may be able to prevent a case that a connection between the first terminal 510 and the connector and a connection between the second terminal 520 and the connector are disconnected due to a short of the conducting wire.

The auxiliary PCB 1150 may have thickness relatively thinner than thickness of the PCB attached to the bottom part of the transmission coil module 1000.

The transmission coil module 1000/1100 shown in FIGS. 10 and 11 can prevent not only a short between an inner conducting wire and an outer conducting wire of the transmission coil 500 but also a phenomenon of contaminating the transmission coil 500 due to the inflow of foreign substance from the external by protecting the transmission coil 500 using the guide board 600.

Transmission coil modules 1000, 1100 according to embodiment of the present invention can include a transmission coil 500 corresponding to etching copper having a relatively big diameter.

The transmission coil 500 corresponding to etching copper may have advantages described in the following.

Power transmission efficiency of a wireless power transmitter varies depending on DCR (direct current resistance) and ACR (alternate current resistance) of the transmission coil 500. The DCR and the ACR correspond to resistance of a conducting wire for direct current and alternate current, respectively.

The DCR and the ACR can be expressed by equation 1 and equation 2, respectively.

DCR=(specific resistance*conducting wire length)/cross section area of conducting wire [Equation 1]

ACR=(specific resistance*conducting wire length)/coil effective area [Equation 2]

In equation 1, the DCR can be presented by a value resulted from dividing multiplication of specific resistance and conducting wire length by conducting wire area. In this case, the specific resistance corresponds to electric resistance of a conducting wire of which a length corresponds to 1 m and a cross section area corresponds to 1 m². The specific resistance corresponds to a unique value determined according to a characteristic of a conducting wire.

In particular, since a conducting wire of the transmission coil 500 corresponding to etching copper has a relatively big diameter, a conducting wire area increases and DCR decreases, thereby improving power transmission efficiency.

In equation 2, the ACR can be presented by a value resulted from dividing multiplication of specific resistance and conducting wire length by a coil effective area. In this case, the coil effective area corresponds to a unique value determined according to a skin depth. The skin depth corresponds to a ratio of an area through which current flows to a unit area.

In particular, since a conducting wire of the transmission coil 500 corresponding to etching copper has a relatively big diameter, the skin depth increases and the ACR decreases, thereby improving power transmission efficiency.

According to an experiment result, DCR of the transmission coil 500 corresponding to etching copper shows resistance of about 0.046 ohm. In this case, DCR of a coil of a general PCB type (a scheme of forming a transmission coil patterned to PCB) shows resistance of about 0.074˜0.134 ohm. In particular, it may be able to reduce resistance component of two or three times.

ACR of the transmission coil 500 corresponding to etching copper shows resistance of about 0.080 ohm. In this case, ACR of a coil of a general PCB type shows resistance of about 0.106˜0.164 ohm. In particular, it may be able to reduce resistance component of one and a half or two times.

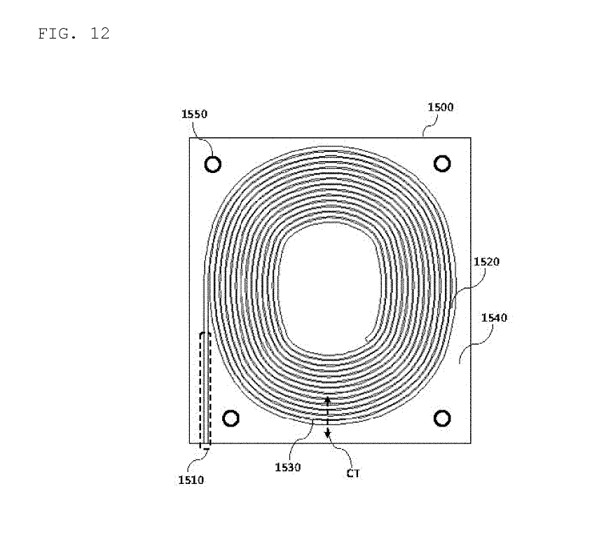

FIG. 12 is a diagram of a transmission coil forming device for manufacturing a transmission coil module according to one embodiment of the present invention.

Referring to FIG. 12, a transmission coil forming device 1500 can include a transmission coil insertion unit 1510, a transmission coil accommodating unit 1520, a transmission coil guide 1530, an upper part board 1540, and a fixing tool insertion unit 1550.

The transmission coil forming device 1500 is coupled with a different transmission coil forming device having a symmetrical shape. A transmission coil is inserted via the transmission coil insertion unit 1510 and the transmission coil is pushed to manufacture a transmission coil having a predetermined shape together with a transmission coil module configured by a device capable of protecting the transmission coil.

The transmission coil insertion unit 1510 can provide a space capable of pushing and inserting one end of a transmission coil. For example, the transmission coil can be implemented by a material (copper (Cu)) having a bending property together with conductivity. If the material is pushed to a space continuously extended as much as a diameter of the material, the material can be continuously inserted in accordance with a shape of the space.

The transmission coil accommodating unit 1520 provides a space for accommodating the transmission coil which is proceeding in a manner of being inserted via the transmission coil insertion unit 1510. The transmission coil accommodating unit 1520 may have a coil form patterned in a spiral form having thickness equal to or greater than predetermined coil thickness. The transmission coil accommodating unit 1520 can make the transmission coil, which has passed the transmission coil insertion unit 1510, to be continuously inserted in a manner of being connected with the transmission coil insertion unit 1520 as a unibody.

A depth of the transmission coil insertion unit 1510 and a depth of the transmission coil accommodating unit 1510 can be configured to be equal to or little bit greater than the half of a diameter of conducting wires of the transmission coil, by which the present invention may be non-limited.

The transmission coil guide 1530 is configured to separate a space in which an inner conducting wire of the transmission coil insertion unit 1510 is accommodated from a space in which an outer conducting wire is accommodated. In particular, the inner conducting wire can be electronically separated from the outer conducting wire by the transmission coil guide 1530. If a width of the transmission coil guide 1530 is controlled, it may be able to optimize wireless power transmission efficiency and a proximity effect described in the following.

The upper part board 1540 corresponds to the remaining region except regions occupied by the transmission coil insertion unit 1510, the transmission coil accommodating unit 1520, the transmission coil guide 1530, and the fixing tool insertion unit 1550. A height of the upper part board may be identical to a height of the transmission coil guide 1530.

The fixing tool insertion unit 1550 provides a space into which a fixing tool is inserted to make a different transmission forming device having a shape symmetrical to a shape of the transmission coil forming device 1500 to be fixed with the transmission coil forming device 1500. For example, the fixing tool may correspond to bolts and nuts, by which the present invention may be non-limited.

If the transmission forming devices are not symmetrically fixed via the fixing tool insertion unit 1550, it is unable to properly insert a transmission coil into the transmission coil forming device 1500.

The transmission coil forming device 1550 can be manufactured by performing a press process on an acrylic board or a plastic board, by which the present invention may be non-limited.

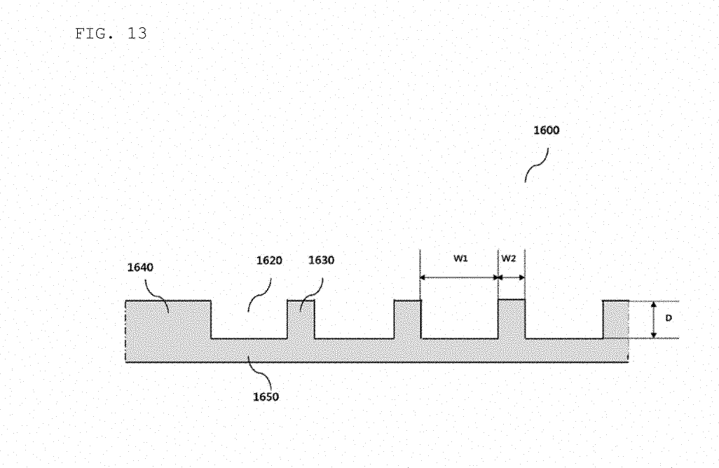

In the following, a method of manufacturing a transmission coil module 1900 using the transmission coil forming device 1550 is explained with reference to FIGS. 13 to 16. The method is explained centering on a structure corresponding to a partial cross section (CT) shown in FIG. 12.

FIGS. 13 to 16 are diagrams for explaining a method of manufacturing a transmission coil module according to one embodiment of the present invention.

FIG. 13 illustrates a structure corresponding to a partial cross section (CT) shown in FIG. 12 of a first transmission coil forming device 1600 having a structure identical to a structure of the transmission coil forming device 1550. The first transmission coil forming device 1600 has a structure identical to the structure of the transmission coil forming device 1500 shown in FIG. 12. For clarity, the structure corresponding to the partial cross section (CT) shown in FIG. 12 is explained.

The first transmission coil forming device 1600 can include a first transmission coil accommodating unit 1620, a first transmission coil guide 1630 for maintaining a space between adjacent conducting wires, a first upper part board 1640, and a first bottom part board 1650.

The first bottom part board 1650 can support the first transmission coil guide 1630 and the first upper part board 1640 in a manner of being formed with the first transmission coil guide 1630 and the first upper part board 1640 as a unibody.

A width (W1) of the first transmission coil accommodating unit 1620 can be configured to be equal to a diameter of a transmission coil to be accommodated. Or, the width (W1) of the first transmission coil accommodating unit 1620 can be configured to be greater than a diameter of a transmission coil to be accommodated to have a margin. For example, if the diameter of the transmission coil corresponds to 0.83 mm, the width (W1) of the first transmission coil accommodating unit 1620 can be configured by 0.83˜0.87 mm.

A height (D) of the first transmission coil accommodating unit 1620 can be configured to be equal to the half of a diameter of a transmission coil. Or, the height (D) of the first transmission coil accommodating unit 1620 can be configured to be greater than the half of the diameter of the transmission coil to have a margin. For example, if the diameter of the transmission coil corresponds to 0.83 mm, the height (D) of the first transmission coil accommodating unit 1620 can be configured by 0.415˜0.435 mm.

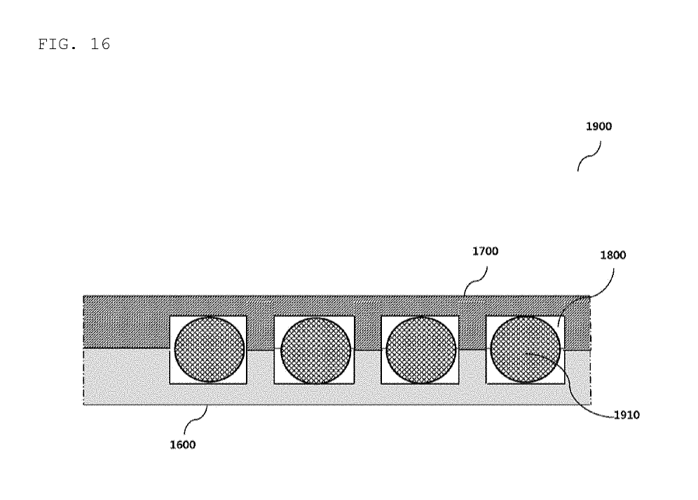

The reason why a reference of the height (D) of the first transmission coil accommodating unit 1620 corresponds to the half of the diameter is because, as shown in FIG. 16, a transmission coil 1900 is inserted into a space, which is formed by contacting the first transmission coil forming device 1600 with a second transmission coil forming device 1700 symmetrical to the first transmission coil forming device 1600.

If the width (W) and the height (D) of the first transmission coil accommodating unit 1620 are identical to the diameter and the half of the diameter of a transmission coil, respectively, the transmission coil is fixed at a preferred position and a space between conducting wires can be maintained well. However, since it is difficult to insert the transmission coil into the space formed by the transmission coil accommodating units, it may be necessary to have a certain margin.

A width (W2) of the first transmission coil guide 1630 may be identical to a predetermined gap between adjacent conducting wires of a transmission coil.

A proximity effect corresponds to a phenomenon occurring between conducting wires closely adjacent to each other. Specifically, the proximity effect corresponds to a phenomenon that impedance of conducting wires increases when magnetic flux density between conducting wires increases and high-frequency current tend to mainly flow on a part close to a different conducting wire. As a gap between conducting wires is getting narrower, the proximity effect may increase.

In particular, as a gap between adjacent conducting wires is getting wider, the proximity effect can be reduced. Yet, if the gap between adjacent conducting wires becomes wider, an effective area of a transmission coil is reduced. The effective area corresponds to a ratio of an area through which current flows to a unit area. If the effective area is reduced, impedance can be increased.

In particular, the impedance influencing on a quality factor of a transmission coil may have a smaller value in accordance with the decrease of the proximity effect and the increase of the effective area. As a gap between adjacent conducting wires increases, the proximity effect is reduced while the effective area is decreased. Hence, in order to make a transmission coil have a preferred quality factor, it is necessary to fix the gap between adjacent conducting wires with an appropriate value.

In particular, the width (W2) of the first transmission coil guide 1630 can be determined by a predetermined value, which is experimentally determined to make a transmission coil have a preferred quality factor, to determine a gap between adjacent conducting wires.

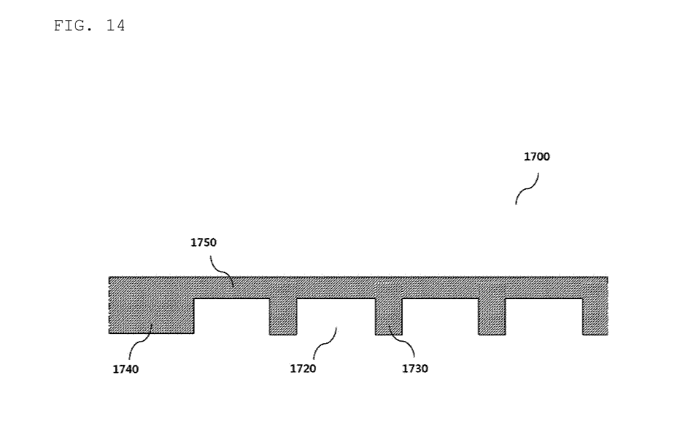

FIG. 14 illustrates a structure corresponding to a partial cross section (CT) shown in FIG. 12 of a second transmission coil forming device 1700 having a structure identical to a structure of the transmission coil forming device 1550. The second transmission coil forming device 1700 has a structure identical to the structure of the transmission coil forming device 1500 shown in FIG. 12. For clarity, the structure corresponding to the partial cross section (CT) shown in FIG. 12 is explained.

The second transmission coil forming device 1700 can include a second transmission coil accommodating unit 1720, a second transmission coil guide 1730 for maintaining a space between adjacent conducting wires, a second upper part board 1740, and a second bottom part board 1750.

The second coil forming device 1700 can be formed with a structure symmetrical to a structure of the first transmission coil forming device 1600 on the basis of an upper side surface of the second upper part board 1740.

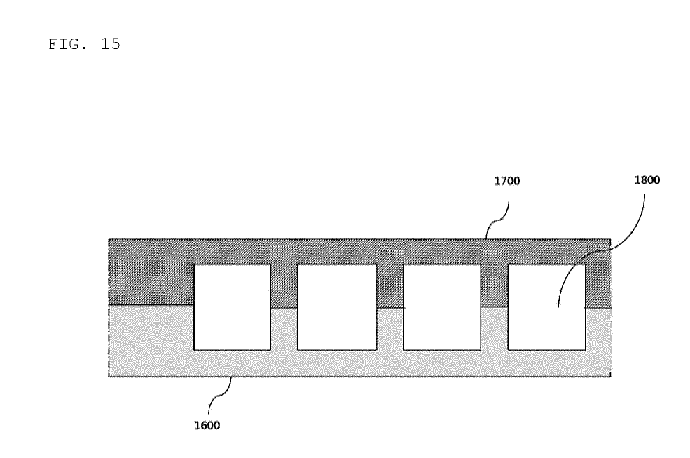

In FIG. 15, the first transmission coil forming device 1600 and the second transmission coil forming device 1700 can be attached to each other in a manner that a face of the first transmission coil forming device is contacted with a face of the second transmission coil forming device.

In this case, a method of attaching the first transmission coil forming device 1600 to the second transmission coil forming device 1700 may include a method of using an additional adhesive sheet (e.g., double-sided tape), a method of applying synthetic resins having bonding strength and insulation (bonding method), and the like, by which the present invention may be non-limited.

A transmission coil accommodating unit 1620 of the first transmission coil forming device 1600 and a second transmission coil accommodating unit 1720 of the second transmission coil forming device 1700 can form a single transmission coil accommodating unit 1800.

As mentioned in the foregoing description, since a height of the first transmission coil accommodating unit 1620 and a height of the second transmission coil accommodating unit 1720 are equal to or greater than the half of a diameter of a transmission coil, a height of the transmission coil accommodating unit 1800 can be equal to or greater than the diameter of the transmission coil.

Referring to FIG. 16, a transmission coil 1910 can be inserted via an insertion hole formed by a transmission coil insertion unit of the first transmission coil forming device 1600 and a transmission coil insertion unit of the second transmission coil forming device 1700.

Conducting wires adjacent to each other of the inserted transmission coil 1910 may have a gap identical to the width (W2) of the first transmission coil guide 1630.

Depending on an embodiment, the width (W2) of the first transmission coil guide 1630 can be configured to have a different size as gradually moving from the inside to the outside of the transmission coil 1910.

According to a result of experiment, if the first transmission coil forming device 1600 and the second transmission coil forming device 1700 are implemented to make the depth of the first transmission coil accommodating unit 1620 and the width (W2) of the first transmission coil guide 1630 have 0.415 mm and 0.2 mm, respectively, and a transmission coil 1910 of which a diameter corresponds to 0.83 mm is inserted, ACR (alternate current resistance) and a quality factor are measured by 0.134 ohm and 38.33, respectively.

On the contrary, if the transmission coil 1910 of which a diameter corresponds to 0.83 mm is wound in a spiral form without the first transmission coil forming device 1600 and the second transmission coil forming device 1700, ACR (alternate current resistance) and a quality factor are measured by 0.176 ohm and 30.54, respectively.

In particular, if the transmission coil module 1900 maintains a gap between adjacent conducting wires of the transmission coil 1910 with a predetermined gap, it is able to optimize performance of the transmission coil 1910. The predetermined gap can be configured to have an optimized quality factor in consideration of a usage, a purpose, and the like of the transmission coil module 1900.

It may be able to attach shielding material to one side of the transmission coil module 1900 to block a magnetic field formed by the transmission coil 1910. In this case, a method of attaching the shielding material may include a method of using an additional adhesive sheet (e.g., double-sided tape), a method of applying synthetic resins having bonding strength and insulation (bonding method), and the like, by which the present invention may be non-limited. And, the shielding material may correspond to a ferrite sheet, by which the present invention may be non-limited.

One side of the transmission coil module 1900 and the shielding material can include at least one or more holes through which conducting wires connected with the transmission coil 1910 are passing. The transmission coil module 1900 to which the shielding material is attached can be attached to a PCB (printed circuit board). The transmission coil 1900 can be connected with a control circuit board through a connector installed in the PCB. The control circuit board corresponds to a board including configurations such as the switches (SW1, SW2), the signal generator 420, and the like that control an operation of the wireless power transmitter 400.

According to one embodiment of the present invention, the transmission coil module 1900 is able to manufacture the transmission coil 1910 having an optimized quality factor by maintaining a gap between adjacent conducting wires of the transmission coil 1910 with a predetermined gap.

And, it is able to prevent a short by physically separating adjacent conducting wires of the transmission coil 1910 from each other.

Moreover, it is able to prevent the transmission coil 1910 from contamination contaminated by foreign substance by protecting the transmission coil from the external.

The method according to the aforementioned embodiment can be implemented with a program readable by a computer in a media in which a program is recorded. The examples of the recording media readable by the computer may include a ROM, a RAM, a CD-ROM, a magnetic tape, a floppy disc, an optical data storing device and the like. And, implementing in a form of a carrier wave (e.g., transmission via the internet and the like) is also included.

The recording media readable by the computer are distributed to computer systems connected with each other via a network and codes readable by the computer can be stored and executed by a distribution scheme. Functional programs, codes, and code segments can be easily induced by programmers of a technical field to which the embodiment belong thereto.

It will be apparent to those skilled in the art that various modifications and variations can be made therein without departing from the spirit and scope of the present specification.

Thus, it is intended that the present specification covers the modifications and variations of this invention that come within the scope of the appended claims and their equivalents.

### INDUSTRIAL APPLICABILITY

The present invention relates to a wireless charging technology and can be applied to a wireless power transmission device that transmits power wirelessly.

1-20. (canceled)

21. A transmission coil module of a wireless power transmitter, comprising:
a transmission coil for transmitting wireless power;
at least one coil guide for preventing a contact between conducting wires adjacent to each other of the transmission coil; and
a guide board containing a coil accommodating unit accommodating the transmission coil.

22. The transmission coil module of the wireless power transmitter of claim 21, wherein the at least one coil guide comprises a plurality of guide structures which are arranged in a direction vertical to a concentric circle direction of the transmission coil and wherein each of a plurality of the guide structures is positioned between the conducting wires adjacent to each other.

23. The transmission coil module of the wireless power transmitter of claim 22, wherein the number of a plurality of the guide structures is identical to the number of winding up the transmission coil.

24. The transmission coil module of the wireless power transmitter of claim 21, wherein a gap between guide structures adjacent to each other among a plurality of the guide structures is identical to a diameter of the conducting wires of the transmission coil.

25. The transmission coil module of the wireless power transmitter of claim 21, wherein a height of the coil accommodating unit is identical to a diameter of the conducting wires of the transmission coil.

26. The transmission coil module of the wireless power transmitter of claim 21, further comprising a shielding material configured to block a magnetic field of the transmission coil in a manner of being attached to the bottom of the guide board.

27. The transmission coil module of the wireless power transmitter of claim 21, wherein the conducting wires of the transmission coil are inserted into the coil accommodating unit in a manner of being inserted into the at least one coil guide.

28. A transmission coil module of a wireless power transmitter, comprising:
a transmission coil for transmitting wireless power;
a first transmission coil forming device containing a first transmission coil accommodating unit and a first transmission coil guide; and
a second transmission coil forming device containing a second transmission coil accommodating unit and a second transmission coil guide,
wherein the first transmission coil forming device is attached to the second transmission coil forming device having a structure symmetrical to a structure of the first transmission coil forming device, and
wherein a transmission coil accommodating unit to accommodate conducting wire of the transmission coil and a transmission coil guide to physically separate conducting wires adjacent to each other of the transmission coil from each other are formed by the attachment.

29. The transmission coil module of the wireless power transmitter of claim 28, wherein the first transmission coil accommodating unit and the second transmission coil accommodating unit symmetrical to the first transmission coil accommodating unit form the transmission coil accommodating unit, and
wherein the first transmission coil guide and the second transmission coil guide symmetrical to the first transmission coil guide form the transmission coil guide.

30. The transmission coil module of the wireless power transmitter of claim 29, wherein the transmission coil accommodating unit has a width identical to a diameter of the conducting wire of the transmission coil.

31. The transmission coil module of the wireless power transmitter of claim 29, wherein the transmission coil accommodating unit has a height identical to a diameter of the conducting wire of the transmission coil.

32. The transmission coil module of the wireless power transmitter of claim 28, wherein the transmission coil guide has a width predetermined to optimize a quality factor of the transmission coil.

33. The transmission coil module of the wireless power transmitter of claim 28, wherein the transmission coil accommodating unit is formed to have a plurality of turns.

34. The transmission coil module of the wireless power transmitter of claim 29, wherein the transmission coil guide is disposed discontinuously along the plurality of turns.

35. The transmission coil module of the wireless power transmitter of claim 28, wherein the first transmission coil accommodating unit and the second transmission coil accommodating unit have a height identical to half of a diameter of the conducting wire of the transmission coil.

36. The transmission coil module of the wireless power transmitter of claim 28, further comprising: a transmission coil inserting unit to provide a space for guiding one end of the transmission coil to the transmission coil accommodating unit.

37. A method of manufacturing a transmission coil module of a wireless power transmitter, comprising the steps of:
generating a first transmission coil forming device containing a first transmission coil accommodating unit configured to accommodate a transmission coil for transmitting wireless power and a first transmission coil guide configured to physically separate conducting wires adjacent to each other of the transmission coil from each other;
generating a second transmission coil forming device having a structure symmetrical to a structure of the first transmission coil forming device;
attaching the first transmission coil forming device to the second transmission coil forming device in a manner that a face of the first transmission coil forming device is contacted with a face of the second transmission coil forming device; and
inserting the transmission coil into a transmission coil accommodating unit which is formed by attaching the first transmission coil forming device to the second transmission coil forming device.

38. The method of manufacturing the transmission coil module of the wireless power transmitter of claim 37, wherein the first transmission coil guide has a width predetermined to optimize a quality factor of the transmission coil.

39. The method of manufacturing the transmission coil module of the wireless power transmitter of claim 37, wherein the transmission coil accommodating unit has a width and height identical to a diameter of the transmission coil.

40. The method of manufacturing the transmission coil module of the wireless power transmitter of claim 37, further comprising the step of attaching a shielding material to one side of the transmission coil module.
